(19) United States
(12) Patent Application Publication
(10) Pub. No.: US 2026/0185637 A1
(43) Pub. Date: Jul. 2, 2026

(54) CORRUGATED FIBER-REINFORCED CYLINDER PIPE AND MANUFACTURING METHOD THEREOF

(71) Applicant: ZHENGZHOU UNIVERSITY, Zhengzhou (CN)

(72) Inventors: Shaowei HU, Zhengzhou (CN); Changxi SHAN, Zhengzhou (CN); Yuxiao YE, Zhengzhou (CN); Panxu SUN, Zhengzhou (CN); Yuquan HU, Zhengzhou (CN); Yaoqun XU, Zhengzhou (CN)

(73) Assignee: ZHENGZHOU UNIVERSITY, Zhengzhou (CN)

(21) Appl. No.: 19/176,206

(22) Filed: Apr. 11, 2025

(30) Foreign Application Priority Data
Dec. 27, 2024 (CN) 202411949945.8

(51) Int. Cl. F16L 9/12; B29D 23/18; B29K 309/00

(52) U.S. Cl. CPC F16L 9/12; B29D 23/18; B29K 2309/00

(57) ABSTRACT

An improved corrugated fiber-reinforced cylinder pipe and a manufacturing method thereof are provided, including: an improved corrugated fiber-reinforced cylinder pipe structure, a prestressed fiber filament winding method, and an improved corrugated fiber-reinforced cylinder pipe manufacturing method. The improved corrugated fiber-reinforced cylinder pipe is manufactured by using a spiral corrugated steel cylinder instead of an annular corrugated steel cylinder, a trough of corrugations is processed, and the filament winding process is improved. Then circumferential and longitudinal steel bars are welded on the steel cylinder, to obtain a novel corrugated steel cylinder composite pipe structure with a smaller prestress loss and a stronger binding force of the steel cylinder. The improved corrugated fiber-reinforced cylinder pipe enhances the prestress retention capability and the resistance to filament breakage of the pipe by using the spiral corrugated steel cylinder and the prestressed fiber filament winding method.

### CROSS REFERENCE TO THE RELATED APPLICATIONS

This application is based upon and claims priority to Chinese Patent Application No. 202411949945.8, filed on Dec. 27, 2024, the entire contents of which are incorporated herein by reference.

### TECHNICAL FIELD

The present invention relates to the field of pipes and pressure vessel manufacturing, specifically to a novel long-distance large-diameter water transmission and drainage pipe and manufacturing technology, and in particular to an improved corrugated fiber-reinforced cylinder pipe and manufacturing method thereof.

### BACKGROUND

In the field of high-pressure water pipes, a conventional pipe material and a structure are susceptible to corrosion, wear and pressure fluctuations during long-term operation, resulting in pipe rupture or leakage. As a novel pipe material, a basalt fiber-reinforced corrugated steel concrete composite pipe (BSCP) is widely used in hydraulic structures because of its excellent mechanical properties and corrosion resistance. However, in the manufacturing process of BSCP, especially during the fiber filament winding, the fiber filament is easy to slip and concentrate at a trough of a corrugated steel cylinder, resulting in uneven stress distribution and affecting the structural integrity and durability of the pipe. A conventional fiber filament winding method has problems such as low winding efficiency, unstable quality, and difficulty in realizing automatic control. In addition, due to the lack of effective fiber filament distribution control means, the slippage and wear of the fiber filaments at the trough are difficult to overcome, limiting an application scope and a service life of the BSCP pipe.

To resolve the foregoing problem, the present invention aims to propose an improved corrugated fiber-reinforced cylinder pipe and a manufacturing method thereof by using a spiral corrugated steel cylinder instead of an annular corrugated steel cylinder, a trough of corrugations is processed, and the filament winding process is improved. Then circumferential and longitudinal steel bars are welded on the steel cylinder, to obtain a novel corrugated steel cylinder composite pipe structure with a smaller prestress loss and a stronger binding force of the steel cylinder. The prestressed fiber filament winding method according to the present invention is efficient and feasible, and the novel corrugated steel cylinder composite pipe structure has stronger ability in anti-filament breakage. This helps overcome the problem of filament breakage and cracking of the BSCP pipe, and provides more reliable technical support for safe operation of hydraulic structures.

After review, quite few of published patents involve the innovation of BSCP pipe structure and the optimization of the prestressed fiber filament winding process, and some of the relevant patents are as follows:

In CN117450330A, a large-diameter fiber-reinforced corrugated steel concrete composite pipe and a preparation method thereof are disclosed. The designed BSCP includes a high-strength concrete layer, a steel corrugated cylinder, a mixed layer, a fiber-reinforced layer with prepreg resin, and a high-density polyethylene outer protective layer that are arranged sequentially from the inside to the outside and are compositely connected to each other. The structure exhibits prestressed fiber filament stress relaxation and wear during production, resulting in a possible decline in product quality.

After review, a small quantity of published patents involve improved filament winding methods for non-BSCP pipes, and some of the relevant patents are as follows:

In CN219768637U, a filament winding equipment on an outer wall of a pipe is disclosed. The steel wire is wound at a constant speed and equidistant distance on the outer surface of the pipe, and the steel wires that can be wound up and down are bonded to each other after filament winding, to ensure a compressive strength of the pipe after filament winding. In CN218664843U, a pipe winding machine is disclosed, to fasten pipes of different sizes, and accelerate a winding speed of pipes. In CN215445390U, a core winding device for processing a prestressed steel cylinder concrete pipe is disclosed. None of the above patents can overcome the problem of filament winding when the prestressed filament are stacked.

### SUMMARY

According to the foregoing problems that the existing BSCP is difficult to wind with high quality and avoid filament breakage and cracking, an improved corrugated fiber-reinforced cylinder pipe and a manufacturing method thereof are provided, to provide more reliable technical support for the optimization of BSCP structure and high-quality production.

The present invention provides an improved corrugated fiber-reinforced cylinder pipe and a manufacturing method thereof, where the improved corrugated fiber-reinforced cylinder pipe structure includes a fiber-reinforced mortar, a spiral corrugated steel cylinder, and a basalt fiber filament.

Further, the basalt fiber filament is wound on the spiral corrugated steel cylinder and covered with unsaturated resin.

Preferably, the unsaturated resin may alternatively be replaced with a resin-like adhesive that can quickly form strength, such as fast-curing AB adhesive or structural adhesive.

Further, the fiber-reinforced mortar is coated on an inner surface of the spiral corrugated steel cylinder, and waits for the fiber-reinforced mortar for curing to form strength.

Preferably, fibers in the fiber-reinforced mortar are short basalt fibers, and the fibers are mainly used to prevent microcracks. The fibers may alternatively be replaced with microcapsule self-healing concrete, shape memory alloy concrete, and other concrete to prevent microcracks.

Further, the spiral corrugated steel cylinder is welded with a longitudinal steel bar and a circumferential steel bar, and surfaces of the longitudinal steel bar and the circumferential steel bar are wrapped with a polyethylene (PE) protective sheathing.

Preferably, the longitudinal steel bar and the circumferential steel bar welded on the spiral corrugated steel cylinder are rebar, but may alternatively be steel cables, steel grid reinforcements, and other reinforcing components.

Further, the spiral corrugated steel cylinder includes a crest and a trough, and a plurality of corrugations are arranged in the trough.

Preferably, a depth of the corrugation set in the trough is not less than ⅓ of a depth of an original trough of the spiral corrugated steel cylinder.

Further, a first layer of basalt fiber filament is wound on the bottom of the corrugation, the first layer of basalt fiber filament is covered with a first layer of unsaturated resin, a second layer of basalt fiber filament is wound on the first layer of unsaturated resin, the second layer of basalt fiber filament is covered with a second layer of unsaturated resin, a third layer of basalt fiber filament is wound on the second layer of unsaturated resin, and the third layer of basalt fiber filament is covered with a third layer of unsaturated resin.

Preferably, three layers of basalt fiber filaments and three layers of unsaturated resin are arranged in the trough, but more layers can be added as required.

The present invention provides an improved corrugated fiber-reinforced cylinder pipe manufacturing method, where the method includes the following steps:
S1: Manufacturing a spiral corrugated steel cylinder;
S2: Spraying fiber-reinforced mortar on an inner surface of the spiral corrugated steel cylinder;
S3: Winding a basalt fiber filament in a trough of the spiral corrugated steel cylinder;
S4: Filling the trough of the spiral corrugated steel cylinder with unsaturated resin;
S5: Welding a longitudinal steel bar and a circumferential steel bar on spiral corrugated steel cylinder; and
S6: Wrapping an outermost surface of the corrugated fiber-reinforced cylinder pipe with a PE protective sheathing.

Preferably, the step S3 and the step S4 further include a prestressed basalt fiber filament winding and curing method: winding a first layer of basalt fiber filament at the bottom of the trough, to ensure that a basalt fiber filament is arranged in each corrugation, and ensure that a prestress loss of the basalt fiber filament is less than 5% during winding, completely covering the first layer of basalt fiber filament with a first layer of unsaturated resin, with a height reaching ⅓ of a height of the trough, and waiting the first layer of unsaturated resin for curing; winding a second layer of basalt fiber filament on the cured first layer of unsaturated resin, covering the second layer of basalt fiber filament with a second layer of unsaturated resin, with a height reaching ⅔ of the height of the trough, and waiting the second layer of unsaturated resin for curing; and winding a third layer of basalt fiber filament on the cured second layer of unsaturated resin, covering the third layer of basalt fiber filament with a third layer of unsaturated resin, with a height completely filling with the trough, and being consistent with a height of the crest, and waiting the third layer of unsaturated resin for curing.

Preferably, in the filament winding process in the step S3 and the step S4, the basalt fiber filament may alternatively be coated with unsaturated resin in advance, and wound on the spiral corrugated steel cylinder while the basalt fiber filament is not yet cured.

Preferably, the step S5 further includes a longitudinal steel bar and circumferential steel bar arrangement method: the longitudinal steel bar is arranged at the crest position of the spiral corrugated steel cylinder through spot welding, and then the circumferential steel bar is arranged at the end of the spiral corrugated steel cylinder, and is connected to each longitudinal steel bar through spot welding.

Compared with that in the prior art, the advantages and positive effects of the present invention are that:
The present invention provides an improved corrugated fiber-reinforced cylinder pipe and a manufacturing method thereof. Compared with that in the prior art, in the present invention, the spiral corrugated steel cylinder is used instead of an annular corrugated steel cylinder, to increase shear resistance of the product; the trough of the corrugations is processed, to increase the ability in anti-filament breakage of the product; and the circumferential and longitudinal steel bars are welded on the steel cylinder, to reduce a probability of stress concentration in the corrugated steel cylinder and reduce a possibility of cracks at the end of the product; to finally obtain a novel corrugated steel cylinder composite pipe structure with a smaller prestress loss and a stronger binding force of the steel cylinder. The prestressed fiber filament winding method according to the present invention is efficient and feasible, and the novel corrugated steel cylinder composite pipe structure has stronger ability in anti-filament breakage. This helps overcome the problem of filament breakage and cracking of the BSCP pipe, and provides more reliable technical support for safe operation of hydraulic structures.

### BRIEF DESCRIPTION OF THE DRAWINGS

To more clearly illustrate the technical solution of embodiments of the present invention, the drawings that need to be used in the descriptions of the embodiments are briefly introduced one by one. It is clear that the drawings in the following descriptions are some embodiments of the present invention, and for a person of ordinary skill in the art, other drawings can also be obtained according to the drawings without creative effort.

FIG. 1 is a schematic diagram of a structure of an improved corrugated fiber-reinforced cylinder pipe according to Embodiment 2;

FIG. 2 is a detailed schematic diagram of trough filament winding of an improved corrugated fiber-reinforced cylinder pipe according to Embodiment 2; and

FIG. 3 is a schematic diagram of filament winding and strengthening process of an improved corrugated fiber-reinforced cylinder pipe according to Embodiment 2.

In the drawings, 1: fiber-reinforced mortar; 2: spiral corrugated steel cylinder; 3: basalt fiber filament; 4: unsaturated resin; 5: longitudinal steel bar; 6: circumferential steel bar; 7: PE protective sheathing; 8: crest; 9: trough; 10: corrugation; 11: first layer of basalt fiber filament; 12:
first layer of unsaturated resin; 13: second layer of basalt fiber filament; 14: second layer of unsaturated resin; 15: third layer of basalt fiber filament; and 16: third layer of unsaturated resin.

### DETAILED DESCRIPTION OF THE EMBODIMENTS

The following clearly and completely describes the technical solutions in embodiments of the present invention with reference to the accompanying drawings in the embodiments of the present invention. It should be noted that, without conflict, the embodiments of the present application and features in the embodiments may be combined with each other.

Many specific details are described in the following descriptions to facilitate a full understanding of the present invention. However, the present invention may also be implemented in other ways different from the descriptions herein. Therefore, the present invention is not limited to the specific embodiments of the following disclosed specification.

Embodiment 1: This embodiment aims at implementing an inner layer manufacturing process of a fiber-reinforced mortar of an improved corrugated fiber-reinforced cylinder pipe. When making the inner layer of the fiber-reinforced mortar, the following steps need to be performed to ensure the quality of the product:
1. Preparation materials: 350 kg/m³ for cement, 650 kg/m³ for river sand, 10 kg/m³ for short basalt fibers (where a length of the selected fibers is between 6-12 mm), and 70 kg/m³ for water.
2. Mortar preparation: In the dry state, the cement and fine aggregates are fully mixed evenly; the short basalt fibers are evenly dispersed in a mixture of the cement and the fine aggregates, to ensure even distribution of the fibers and no agglomerates; and gradually add metered water while stirring until the mortar reaches the proper consistency and fluidity.
3. Spraying process: An internal surface of the spiral corrugated steel cylinder is ensure to be clean, free of oil and dust, to improve the adhesion of the mortar; professional spraying equipment is used, to evenly spray the prepared short basalt fiber mortar on the inner surface of the spiral corrugated steel cylinder; pressure and a speed of spraying are controlled, to ensure uniformity and a thickness of the mortar layer; and the thickness of the mortar layer is controlled, with generally a thickness of 3-5 mm, to ensure adequate protection and strength.
4. Curing and protection: After the spraying is completed, the product is placed in a standard curing room for curing for 7-14 days, waiting for the inner layer of the fiber-reinforced mortar to be completely cured, and then the microcracks of the finished product are checked.

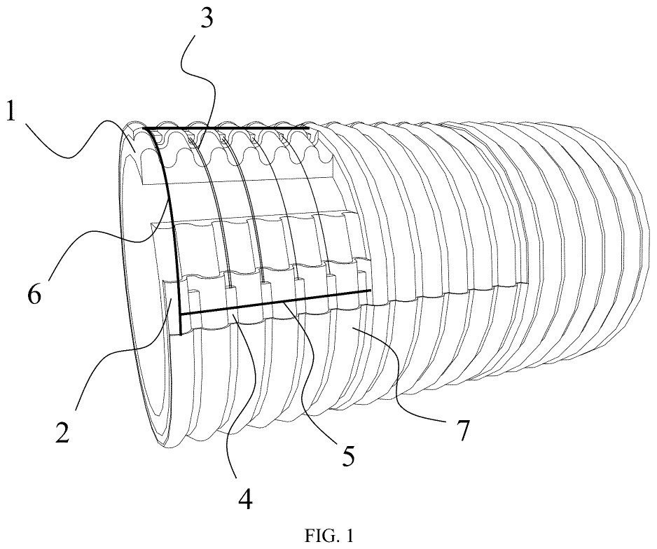

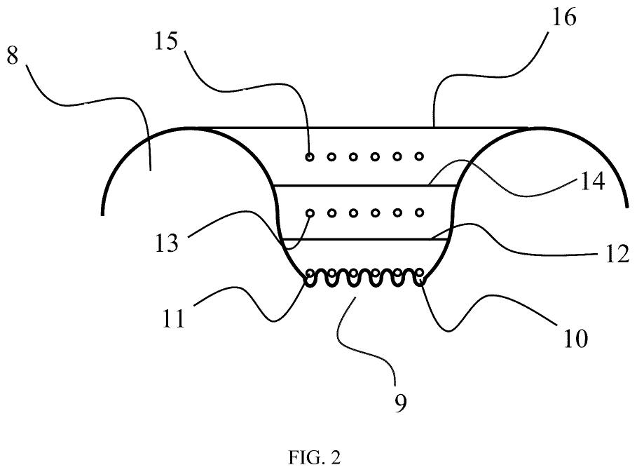

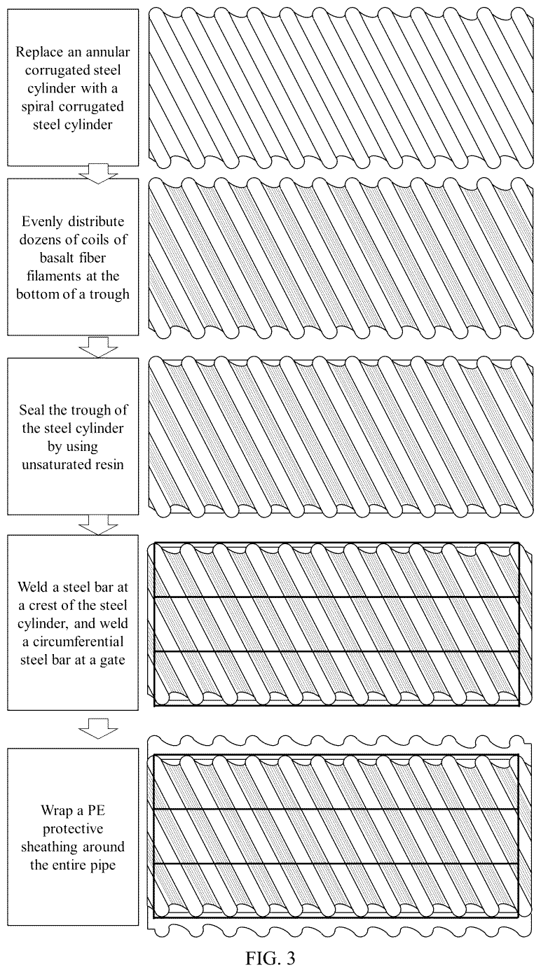

Embodiment 2: This embodiment aims at implementing a design of an improved corrugated fiber-reinforced cylinder pipe. Refer to FIG. 1 to FIG. 3, when making a novel corrugated steel cylinder composite pipe structure, the following steps need to be performed to ensure the correctness of product making:
1. Replace an annular corrugated steel cylinder in an original BSCP structure with a spiral corrugated steel cylinder, first press out a crest (8) and a trough (9) of a thin steel plate, and then use a plate rolling machine to roll the thin steel plate into a cylinder and weld the thin steel plate into a steel cylinder, to ensure that the steel cylinder is fully welded on both surfaces along a splicing line and ensure that there is no gap.
2. Spray modulated fiber-reinforced mortar (1) in the spiral corrugated steel cylinder, to form a basalt fiber-reinforced concrete inner cushion.
3. Wrap a first layer of basalt fiber filament (11) at the bottom of the trough (9), to ensure that a basalt fiber filament (3) is arranged in each corrugation (10), and keep a prestress loss less than 5% during winding.
4. A first layer of basalt fiber filament (11) is completely covered with the first layer of unsaturated resin (12), with a height reaching ⅓ of a height of the trough (9), and the first layer of unsaturated resin (12) is waiting for curing for at least 4 hours; and a second layer of basalt fiber filament (13) is wound on the first layer of cured unsaturated resin (12), and the second layer of basalt fiber filament (13) is covered with a second layer of unsaturated resin (14), with a height reaching ⅔ of the height of the trough (9), and the second layer of unsaturated resin (14) is waiting for curing for at least 4 hours.
5. A third layer of basalt fiber filament (15) is wound on the cured second layer of unsaturated resin (14), and the third layer of basalt fiber filament (15) is covered with a third layer of unsaturated resin (16), with a height completely filling the trough (9), and being consistent with a height of the crest (8), and the third layer of unsaturated resin (16) is waiting for curing for at least 4 hours.
6. A longitudinal steel bar (5) is arranged at the crest (8) position of the spiral corrugated steel cylinder (2) through spot welding, and a diameter of the longitudinal steel bar is 12 mm; and then a circumferential steel bar (6) is arranged at the end of the spiral corrugated steel cylinder (2), and a diameter of the circumferential steel bar is 10 mm. The circumferential steel bar is connected to each longitudinal reinforcement (5) in the form of spot welding, and a spacing of a welding point is not more than 200 mm.
7. Wrap a PE protective sheathing (7) on the outside of the entire pipe, wrap the spiral corrugated steel cylinder that has been wound with the basalt fiber filament (3) with a PE tape, and then heat the entire pipe section on heating equipment, to melt the PE tape into the entire PE protective sheathing (7), and a thickness of the PE protective sheathing (7) is not less than 2 mm.

Embodiment 3: This embodiment aims at implementing an installation method of an improved corrugated fiber-reinforced cylinder pipe. when installing the improved corrugated fiber-reinforced cylinder pipe, the following steps need to be performed to ensure the normal use of the product:
1. Ensure that the installation site has been cleaned, there are no sharp obstacles in the installation part, and check whether the part is smooth and solid, to ensure the stability of the pipe after installation.
2. Before installation, conduct a comprehensive inspection of the improved corrugated fiber-reinforced cylinder pipe, to ensure that there is no damage, deformation, or defect.
3. Use a crane or forklift to slowly lift the pipe to the installation position, to ensure that the pipe is not twisted or violently impacted during lifting and installation, and avoid damage to the PE protective sheathing and internal structure.
4. Connect both ends of the pipe with an adjacent pipe or interface, to ensure tightness and stability of connection, and adjust a position of the pipe, to ensure that a pipe axis is consistent with a design axis, and a pipe slope meets requirements of use.
5. After the pipe installation, a pressure test is performed, to verify tightness and strength of the pipe.
6. After 24 and 60 months of service, check whether the PE protective sheathing has signs of wear, aging or damage, and check whether there is leakage at pipe connections.

What is claimed is:

1. An improved corrugated fiber-reinforced cylinder pipe structure, wherein the improved corrugated fiber-reinforced cylinder pipe structure comprises a fiber-reinforced mortar, a spiral corrugated steel cylinder, and a basalt fiber filament, wherein the basalt fiber filament is wound on the spiral corrugated steel cylinder and covered with unsaturated resin, and the fiber-reinforced mortar is coated on an internal surface of the spiral corrugated steel cylinder;
the spiral corrugated steel cylinder is welded with a longitudinal steel bar and a circumferential steel bar, and a polyethylene (PE) protective sheathing is wrapped on surfaces of the longitudinal steel bar and the circumferential steel bar;
the spiral corrugated steel cylinder comprises a crest and a trough, and a plurality of corrugations are arranged in the trough; and
a first layer of the basalt fiber filament is wound on a bottom of each of the plurality of corrugations, the first layer of the basalt fiber filament is covered with a first layer of the unsaturated resin, a second layer of the basalt fiber filament is wound on the first layer of the unsaturated resin, the second layer of the basalt fiber filament is covered with a second layer of the unsaturated resin, a third layer of the basalt fiber filament is wound on the second layer of the unsaturated resin, and the third layer of the basalt fiber filament is covered with a third layer of the unsaturated resin.

2. An improved corrugated fiber-reinforced cylinder pipe manufacturing method, comprising the following steps:
S1: manufacturing a spiral corrugated steel cylinder;
S2: spraying a fiber-reinforced mortar on an inner surface of the spiral corrugated steel cylinder;
S3: winding a basalt fiber filament in a trough of the spiral corrugated steel cylinder;
S4: filling the trough of the spiral corrugated steel cylinder with unsaturated resin;
S5: welding a longitudinal steel bar and a circumferential steel bar on the spiral corrugated steel cylinder; and
S6: wrapping an outermost surface of the improved corrugated fiber-reinforced cylinder pipe with a PE protective sheathing.

3. The improved corrugated fiber-reinforced cylinder pipe manufacturing method according to claim 2, wherein the step S3 and the step S4 further comprise a prestressed basalt fiber filament winding and curing method, the prestressed basalt fiber filament winding and curing method comprises: winding a first layer of the basalt fiber filament at a bottom of the trough, to ensure that the basalt fiber filament is arranged in each of a plurality of corrugations, and ensure that a prestress loss of the basalt fiber filament is less than 5% during winding, completely covering the first layer of the basalt fiber filament with a first layer of the unsaturated resin, with a height reaching ⅓ of a height of the trough, and waiting the first layer of the unsaturated resin for curing to obtain a cured first layer of the unsaturated resin;
winding a second layer of the basalt fiber filament on the cured first layer of the unsaturated resin, covering the second layer of the basalt fiber filament with a second layer of the unsaturated resin, with a height reaching ⅔ of the height of the trough, and waiting the second layer of the unsaturated resin for curing to obtain a cured second layer of the unsaturated resin; and
winding a third layer of the basalt fiber filament on the cured second layer of the unsaturated resin, covering the third layer of the basalt fiber filament with a third layer of the unsaturated resin, with a height completely filling with the trough, and being consistent with a height of a crest, and waiting the third layer of the unsaturated resin for curing.

4. The improved corrugated fiber-reinforced cylinder pipe manufacturing method according to claim 2, wherein the step S5 further comprises a longitudinal steel bar and circumferential steel bar arrangement method, the longitudinal steel bar and circumferential steel bar arrangement method comprises: the longitudinal steel bar is arranged at a crest position of the spiral corrugated steel cylinder through spot welding, and the circumferential steel bar is arranged at an end of the spiral corrugated steel cylinder, and is connected to each longitudinal steel bar through the spot welding.
